(19) United States
(12) Patent Application Publication
(10) Pub. No.: US 2009/0147983 A1
(43) Pub. Date: Jun. 11, 2009

(54) METHOD AND SYSTEM OF A LINKAGE ASSEMBLY FOR USE IN AN ELECTROACOUSTIC TRANSDUCER

(76) Inventor: Mekell Jiles, Flossmoor, IL (US)

Correspondence Address: MARSHALL, GERSTEIN & BORUN LLP, 233 SOUTH WACKER DRIVE, 6300 SEARS TOWER, CHICAGO, IL, 60606-6357, US

(21) Appl. No.: 11/952,913

(22) Filed: Dec. 7, 2007

(51) Int. Cl. H04R 1/02; H04R 31/00

(52) U.S. Cl. 381/386; 29/594

(57) ABSTRACT

A three-dimensional linkage assembly for an electroacoustic transducer comprises a first panel having a first structure and a first opening and a second panel having a second structure and a second opening. The first structure may be disposed within the second opening and the second structure may be disposed within the first opening. The first panel and the second panel may be joined together by welding, mechanical coupling, or bonding. Each of the first and second panels comprises a frame and a retaining portion attached the first structure and the second structure to the frame.

### TECHNICAL FIELD

This patent relates to electroacoustic transducers, and more particularly, to a three-dimensional linkage assembly for use in a receiver and a method of manufacturing the same.

### BACKGROUND

Conventionally, a receiver or a speaker utilizes moving parts such as, an armature, a diaphragm, and a drive rod to generate acoustic energy in the ear canal of the individual using a listening device (e.g., a hearing aid, an earphone, a headset or the like). The armature may be coupled to the diaphragm via the drive rod for driving the diaphragm to displace air, thereby creating acoustic energy.

One-piece drive rods may be manufactured from a single thin foil including multiple preforms. Through multiple processing steps, individual one-piece drive rods may be formed from the preforms. Usually the drive rod includes a movable portion and a fixed portion attached to the movable portion. The movable portion may couple the armature to the diaphragm and the fixed portion may be coupled to an inner wall of the receiver housing. As the receivers may be formed with different shapes and sizes, the one-piece drive rods having different dimensions may be accommodated. For example, a thinner receiver may require a fixed portion having a shorter length without modifying the dimension of the movable portion, while another receiver may require a fixed portion having a longer length without modifying the dimension of the movable portion. Though both the drive rods have a common movable portion with different fixed portions, it is difficult to form different drive rods on the same thin foil at the same time.

### BRIEF DESCRIPTION OF THE DRAWINGS

For a more complete understanding of the disclosure, reference should be made to the following detailed description and accompanying drawings wherein:

FIGS. 1-8 illustrate a sequence of manufacturing steps in an embodiment for forming a three-dimensional linkage assembly; and

FIG. 9 is a cross-sectional view of a three-dimensional linkage assembly for an electroacoustic transducer according to an embodiment of the invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

While the present invention is susceptible to various modifications and alternative forms, certain embodiments are shown by way of example in the drawings and these embodiments will be described in detail herein. It should be understood, however, that this disclosure is not intended to limit the invention to the particular forms described, but to the contrary, the invention is intended to cover all modifications, alternatives, and equivalents falling within the spirit and scope of the invention defined by the appended claims.

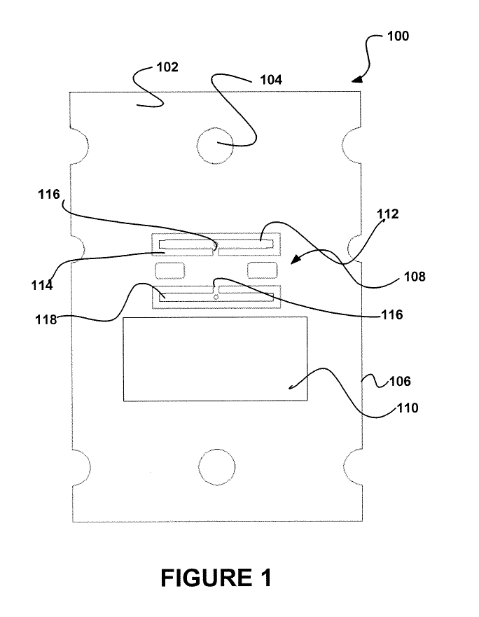

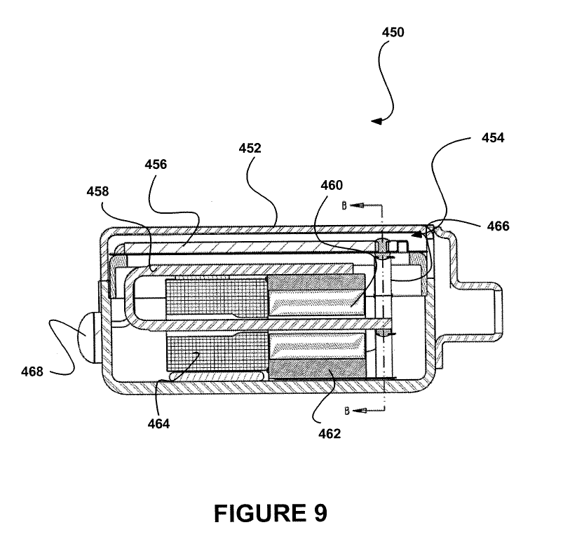

FIGS. 1-8 illustrate a three-dimensional linkage assembly 466 for an electroacoustic transducer 450 (as shown in FIG. 9). With reference to FIG. 1, a first sub-panel 100 may include a frame 102, a plurality of alignment apertures 104, and a plurality of cuts or saw kerfs 106. The apertures 104 may be provided to ensure proper placement and alignment of the panel when more than one panel are assembled together to form a plurality of linkage assemblies 466. Further, the apertures 104 may be used to facilitate handling and moving of the panel during the manufacturing process.

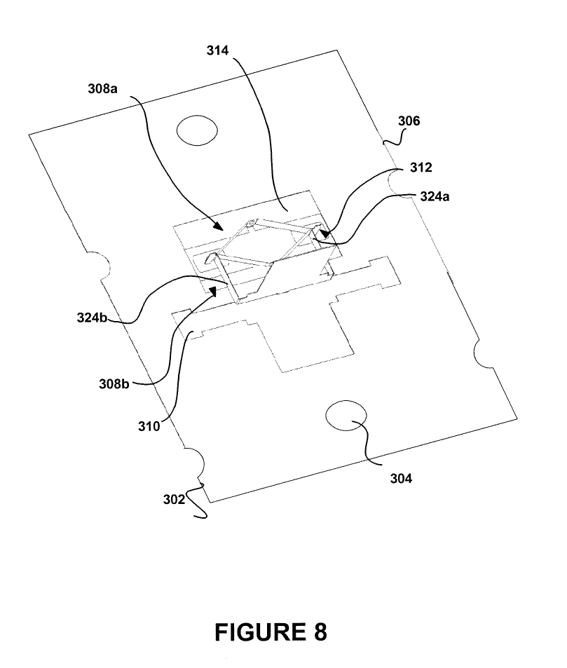

The cuts or saw kerfs 106 may be realized by cutting or forming at predetermined locations of the panel to produce a plurality of sub-panels 100 for carrying the linkage assemblies 466. Cutting is used merely to describe any suitable process of defining the cuts or saw kerfs 106 in the panel 100. The forming process may be performed as an initial process or during later processing, such as bending and forming of the linkage assembly 466 after it is singulated from the frame 302 (as shown in FIG. 8). Only one sub-panel 100 is illustrated for simplicity. The singulation or dicing of sub-panels 100 from a strip may be realized by using a saw, a laser, scribing or breaking or any other suitable singulation process. The sub-panel 100 may further include a first opening 110 and a second opening 114. The first opening 110 may be formed by removing a portion of the sub-panel 100 to accommodate the mounting of other component in the opening 110.

The second opening 114 may be similarly formed and structured as the first opening 110, except that the second opening defines an upper linkage assembly 108 therein. As shown, the upper linkage assembly 108 may include a first preform 112 and a second preform 118. The preforms 112, 118 formed in the opening 114 may be attached to the frame 102 by a retaining portion 116. Although two preforms 112, 118 are depicted, it is possible to eliminate one of the preforms or add additional preforms without departing from the scope of the invention. The retaining portion 116 may be used to hold the preforms 112, 118 at a position relative to the frame 102. The preforms 112, 118 may be generally flat and parallel to the panel.

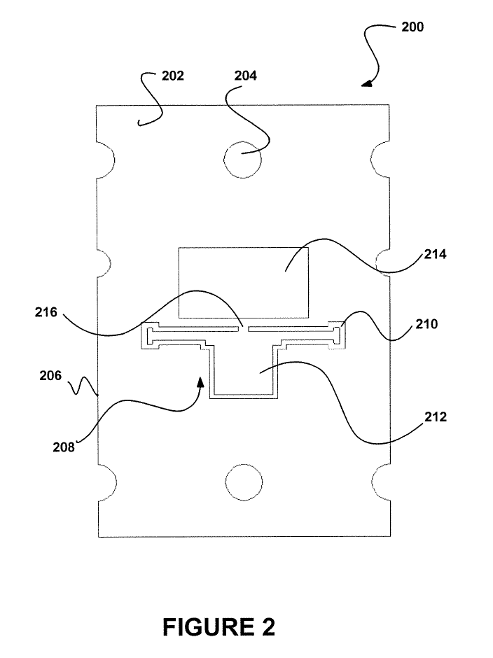

Now referring to FIG. 2, a second sub-panel 200 is provided. Like the first sub-panel 100, the second sub-panel 200 may include a frame 202, a plurality of alignment apertures 204, a plurality of cuts or saw kerfs 206, a first opening 210, and a second opening 214. The second opening 214 may be formed by removing a portion of the sub-panel 200 to accommodate the upper linkage assembly 108 (as shown in FIG. 1) within the opening 214. A lower linkage assembly 208 formed in the first opening 210 may be coupled to the frame 202 via a retaining portion 216. The lower linkage assembly 208 includes a preform 212 that may be substantially flat and parallel to the panel. As shown, the retaining portion 216 may hold the preform 212 in place within the opening 210 and relative to the frame 202. It will be understood that one or more preforms and/or retaining portions may be included without departing from the scope of the invention. The frame 202, the apertures 204, and the saw kerfs 206 may be identical to the frame 102, the apertures 104, and the saw kerfs 206 (as shown in FIG. 1) without departing from the scope of the invention.

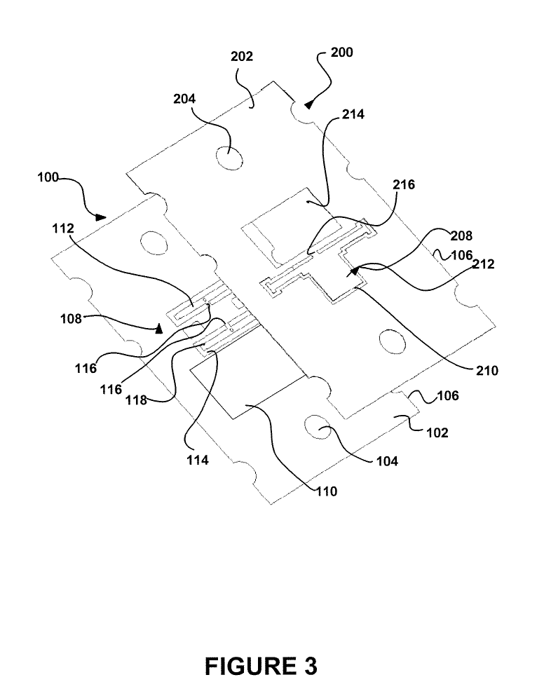

Now referring to FIG. 3, the second sub-panel 200 may be placed directly over the first sub-panel 100 such that the apertures 204 register and align with the apertures 104. When the alignment is achieved, the upper linkage assembly 108 may be positioned within the second opening 214 of the sub-panel 200. The lower linkage assembly 208 may be positioned within the first opening 110 of the first sub-panel 100 in a similar manner to the upper linkage assembly 108. Once the lower and upper linkage assemblies 108, 208 are properly positioned in the openings 110, 214, a bending operation may be performed subsequently. Although two panels 100, 200 are provided, it is possible to eliminate one of the panels or add additional panels without departing from the scope of the invention.

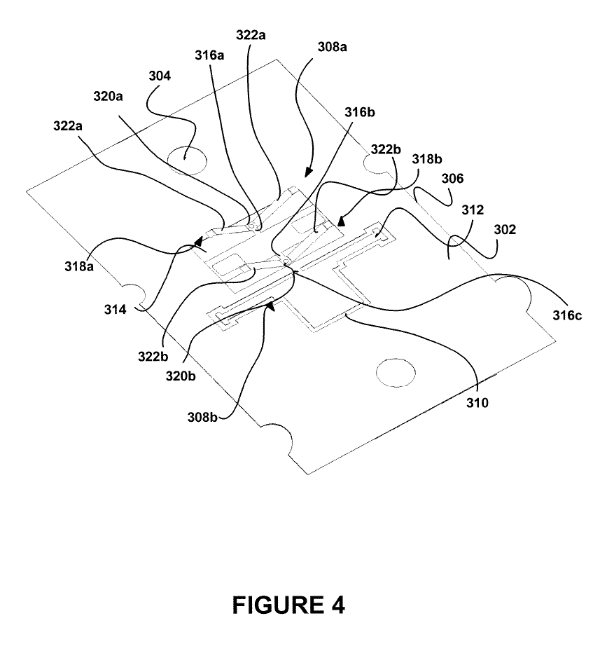

Referring to FIG. 4, the panels 100, 200 (as shown in FIGS. 1-2) may be held together by placing one of the panels over the other panel using any known technique. As shown in FIG. 4, the second panel 200 may be placed over the first panel 100. Like elements in FIG. 4 are identified with like references in FIGS. 1-3 wherein, for example, element 302 corresponds to element 102 and 202. A bending operation may be performed by bending either one of the assemblies 308a or 308b. Alternatively, both the assemblies 308a, 308b may be bent at the same time. As shown, a first and second preforms 318a, 318b of the upper assembly 308a may be bent in the same direction to form a V-shaped. In this case, the preforms 318a, 318b are bent in an upward direction (from the top view). At the extreme ends of the preforms 318a, 318b, tabs may be formed by bending the ends slightly downward such that the tabs are parallel to the frame 302. Connecting members 320a, 320b between leg members 322a, 322b of the preforms 318a, 318b may be created. Retaining portions 316a, 316b may be attached to the leg members 322a, 322b via the connecting members 320a, 320b. The leg members 322a may have a length that is substantially similar to the leg members 322b, depending on the desired applications. The thickness of the leg members 322a may be substantially similar to the thickness of the leg members 322b. Alternatively, the length of the leg members 322a, 322b may be different, thus the shape of the preforms 318a, 318b may be different after the leg members 322a, 322b are bent without departing from the scope of the invention.

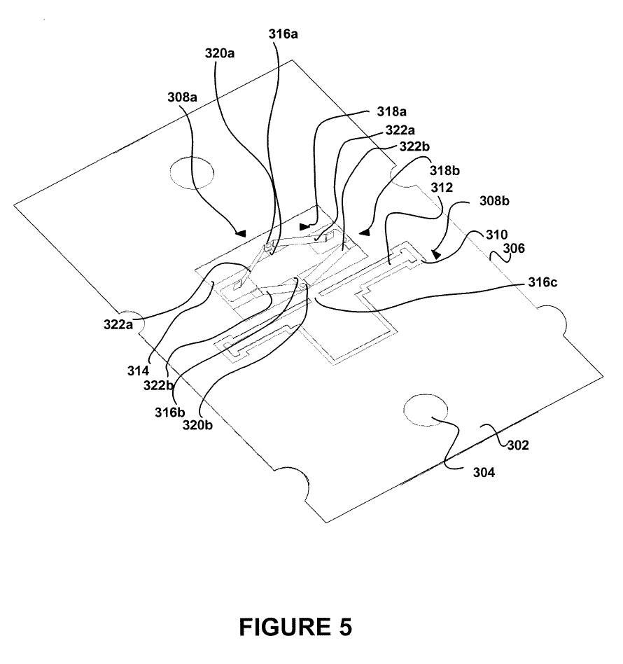

The connecting member 320a may be bent 90 degree away from the plane such that the connecting member 320a is perpendicular to the frame 302 at an upright position and faces toward the second preform 318b. This is shown in FIG. 5, where the leg members 322a are no longer facing upward after the connecting member 320a is bent 90 degree.

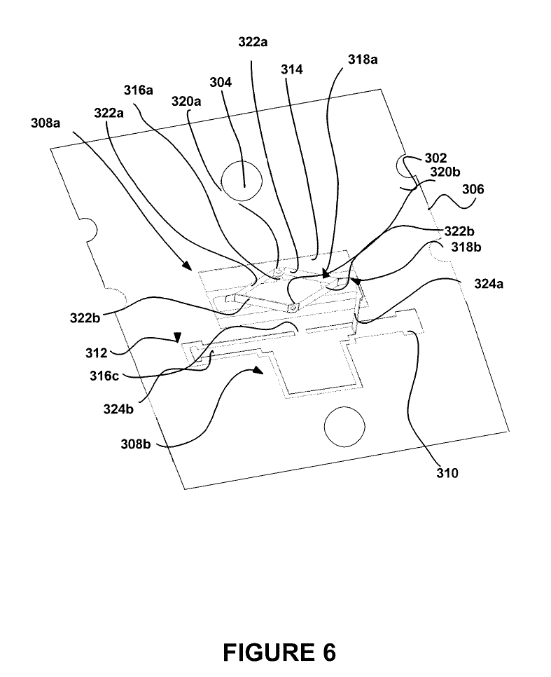

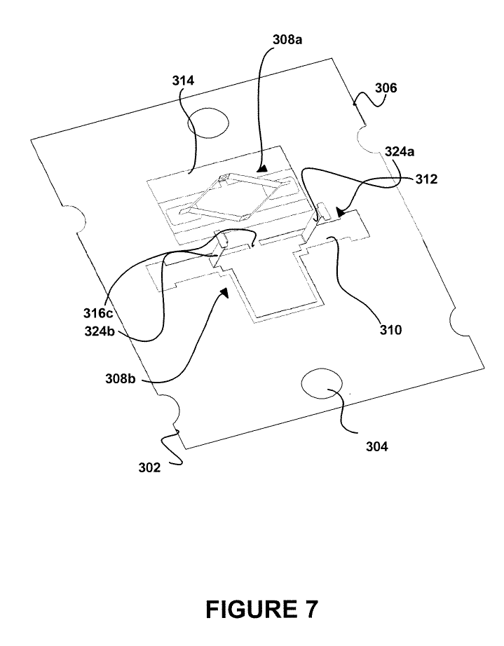

The connecting member 320b may be bent in a similar manner to that described above, as illustrated in FIG. 6. As shown, the 90 degree bending on the connecting member 320b results in the leg members 322b facing the leg members 322a. A “diamond shape” on the upper linkage assembly 308a is formed by fixedly attaching tabs of the preforms 318a, 318b together by bonding, welding, crimping or any other suitable technique. The “diamond shape” upper linkage assembly 308a may still be held in place and attached to the frame 302 by the retaining portions 316a, 316b. The preform 312 of the lower linkage assembly 308b may be bent by bending a leg member 324a of the preform 312. A similar bending operation may be performed to form a second leg member 324b as illustrated in FIG. 7. At the extreme ends of the first and second leg members 324a, 324b, tabs may be formed by 90 degree bending a portion of the first and second leg members 324a, 324b outwardly and substantially parallel to the plane. A connecting member 326 between the legs 324a, 324b may be bent in the subsequent process and may be coupled to the frame 302 via the retaining portion 316c.

Now referring to FIG. 8, at least a portion of the retaining portion 316c or a portion of the connecting member 326 may be bent 90 degree away from the plane such that the entire lower linkage assembly 308b faces toward the upper linkage assembly 308a. The tabs of the lower linkage assembly 308b may be bent around the tabs of the upper linkage in the same direction as the upper linkage assembly 308a. In this case the leg member 324a is bent in an upward direction so that the leg member 324a is substantially perpendicular to the frame 302. A laser, such as used for welding, may be used to weld and hence fixedly attach the assemblies 308a, 308b together in order to complete the assembly. Other examples of attachment such as bonding, crimping and the like may be used. The three-dimensional linkage assembly 466 may be singulated from the frame 302 by removing or cutting along the retaining portions 316a, 316b, 316c to form a plurality of linkage assembly. Optionally, the linkage assembly 466 may be left attached to the frame 302 and is now ready to be incorporated into the transducer 450 (as shown in FIG. 9). As shown, the upper linkage assembly or structure 308a may be a movable portion and the lower linkage assembly or structure 308b may be a fixed portion. Since the movable portion and the fixed portion are not formed from the same panel, it is easier to modify the dimension of one of the portions and attaches the modified portion to another common portion without modifying both the portions.

FIG. 9 illustrates an embodiment of an electroacoustic transducer 450. The electroacoustic transducer 450 may be a receiver, a speaker, a microelectromechanical system (MEMS) based silicon receiver or the like, depending on the desired applications. It will be understood that one or more transducers may be included. The electroacoustic transducer 450 includes a housing 452 and a driving assembly 454. The housing 452 may take the form of various shapes and have a number different of sizes. The driving assembly 454 may include a diaphragm 456, an armature 458, drive magnets 460, a magnetic yoke 462, a drive coil 464, and a linkage assembly 466. An optional bobbin may be provided as part of the driving assembly 454 to drive other working components within the housing 452. At least one vent may be provided and communicating a front volume, a back volume, or a combination therefore, to the outside surrounding. In other embodiments, the vent may serve to equalize the pressure between the volumes or the volume and the outside surrounding. The diaphragm 456 and the armature 458 may be operably joined to the linkage assembly 466. As shown, the movable portion of the assembly 466 couples the armature 458 to the diaphragm 456 and the fixed portion of the assembly 466 may be coupled to an inner wall of the receiver housing 452. In other embodiments, more than one diaphragm may be used in the electroacoustic transducer 450. In operation, a current representing on input audio signal from an electrical terminal 468 is supplied to the drive coil 464. The armature 458 vibrates in response to the electromagnetic forces generated by the magnetic flux produced by the magnetic yoke 462, drive coil 464, and the drive magnets 460. In turn, the movement of the armature 458 leads to the movement of the linkage assembly 466. The diaphragm 456 moves in response to the corresponding motion of the linkage assembly 466, therapy creating an acoustic signal.

It will be appreciated that numerous variations to the above-mentioned approaches are possible. Variations to the above approaches may, for example, include performing the above steps in a different order. Further, more than one linkage assembly may be mounted within a transducer. In another example, the linkage assembly may be formed as part of other components of the driving assembly. In yet another example, other components of the driving assembly may be formed in a similar manner.

All references, including publications, patent applications, and patents, cited herein are hereby incorporated by reference to the same extend as if each reference were individually and specifically indicated to the incorporated by reference and were set forth in its entirety herein.

Preferred embodiments of this invention are described herein, including the best mode known to the inventor for carrying out the invention. It should be understood that the illustrated embodiments are exemplary only, and should not be taken as limiting the scope of the invention.

What is claimed is:

1. A method of forming a three-dimensional linkage assembly from at least two panels comprising:
providing a first panel, the first panel comprising a first structure formed in the first panel, a first opening and a first retaining portion attaching the first structure to the first panel;
providing a second panel, the second panel comprising a second structure formed in the second panel, a second opening and a second retaining portion attaching the second structure to the second frame;
joining the first and second panels so that the first structure is aligned relative to the second opening and the second structure is aligned relative to the first opening; and
joining the first structure and the second structure to form a three-dimensional linkage assembly.

2. The method of claim 1, wherein each of the first and second structure comprises at least one leg member and at least one connecting member joining the leg member to the first panel, the second panel, or both the first and second panels via the first retaining portion, the second retaining portion, or both the first and second retaining portions.

3. The method of claim 2, wherein the first structure comprises a first leg member and a second leg member, the method further comprising bending the first and second leg members in a first direction and is substantially perpendicular to the first frame.

4. The method of claim 3, wherein the second structure comprises a third leg, a fourth leg, the method further comprising bending the third and fourth legs in the first direction and is substantially perpendicular to the second frame.

5. The method of claim 4, further comprising joining the first leg to the third leg and joining the second leg to the fourth leg.

6. The method of claim 5, further comprising singulating the first and second retaining portions from the first and second frames.

7. The method of claim 5, wherein joining the first structure and the second structure comprises at least one of: welding, mechanically coupling and bonding.

8. The method of claim 1, wherein the first structure comprises a first set of leg members, a second set of leg members, and first and second connecting members joining the first and second set leg members to the first frame via the first retaining portion, the method further comprising bending the first and second leg set members to form a V-shaped.

9. The method of claim 8, wherein the second structure comprises a first leg, a second leg, and a connecting member joining the first and second leg to the second frame via the second retaining portion, the method further comprising bending the first and second leg member.

10. The method of claim 1, further comprising joining the linkage assembly to a transducer, and separating the linkage assembly from the first and second panels.

11. The method of claim 10, wherein the transducer is a receiver, a speaker, or a microelectromechanical system based silicon receiver.

12. An intermediate product of manufacture of a three-dimensional linkage assembly for an electroacoustic transducer comprising:
a first panel having a first structure and a first opening; and
a second panel having a second structure and a second opening;
wherein the first panel and the second panel is joined together, the first structure is aligned relative to the second opening and the second structure is aligned relative to the first opening.

13. The assembly of claim 12, wherein each of the first and second panels comprises a frame and a retaining portion attached the first structure and the second structure to the frame.

14. The assembly of claim 13, wherein the first structure is joined to the second structure to form a linkage assembly.

15. The assembly of claim 14, wherein the first structure and the second structure being joined by at least one of: welding, mechanical coupling and bonding.

16. The assembly of claim 13, wherein the first structure comprises a movable portion and the second structure comprises a fixed portion, the movable portion is coupled to a driving assembly to drive at least one component of the driving assembly.

17. The assembly of claim 16, wherein the driving assembly is a diaphragm, a drive magnet, a magnetic yoke, a bobbin, an armature, or a drive coil.

18. The assembly of claim 13, wherein the fixed portion is coupled to an inner surface of a transducer housing.
